(19) United States
(12) Patent Application Publication
(10) Pub. No.: US 2012/0143982 A1
(43) Pub. Date: Jun. 7, 2012

(54) Methods and Communications Node for Routing Communications Using a Bi-Level Addressing Scheme

(75) Inventors: Gert Oster, Jarfalla (SE); John Baldwin, Coventry (GB)

(73) Assignee: TELEFONAKTIEBOLAGET L M ERICSSON (PUBL), Stockholm (SE)

(21) Appl. No.: 13/141,539

(22) PCT Filed: Dec. 26, 2008
(86) PCT No.: PCT/IB2008/003626

§ 371 Date: Dec. 1, 2011

(51) Int. Cl. G06F 15/16

(52) U.S. Cl. 709/217

(57) ABSTRACT

Methods and a communications node provide for routing communications over interconnected operator networks. These communications can be routed between individuals and/or organizations. Typically these communications are routed based upon information located in a database (410) and stored in session initiation protocol (SIP) communications.

### TECHNICAL FIELD

The exemplary embodiments herein generally relate to systems, devices, software, methods and, more particularly, to mechanisms and techniques for routing messages through interconnected networks.

### BACKGROUND

As technological capabilities continue to expand, the options for communications have become more varied. For example, in the last 30 or so years in the telecommunications industry, personal communications have evolved from a home having a single rotary dial telephone, to a home having multiple telephone, cable and/or fiber optic lines that accommodate both voice and data. Additionally cellular phones and Wi-Fi have added a mobile element to communications. Similarly, in the entertainment industry, 30 years ago there was only one format for television and this format was transmitted over the air and received via antennas located at homes. This has evolved into both different standards of picture quality such as, standard definition television (SDTV), enhanced definition TV (EDTV) and high definition TV (HDTV), and more systems for delivery of these different television display formats such as cable and satellite. Additionally, services have grown to become overlapping between these two industries. As these systems continue to evolve in both industries, the service offerings will continue to merge and new services can be expected to be available for a consumer. Also some of these services are expected to be based on the technical capability to process and output more information.

Another related technology that impacts both the communications and entertainment industries is interconnected networks. The physical structure of these communication networks and associated communication streams have also evolved to handle an increased flow of data. Servers have more memory than ever before, communications links exist that have a higher bandwidth than in the past, processors are faster and more capable and protocols exist to take advantage of these elements. These communications networks can be any network or networks linking users and businesses. As consumers' usage of these networks grows, this growth can fuel the creation of more networks, which can be interconnected, for providing services. These services may include, for example, Internet Protocol television (IPTV, referring to systems or services that deliver television programs over a network using IP data packets), Internet radio, video on demand (VoD), live events, voice over IP (VoIP), and other web related services received singly or bundled together. Also, along with the changes in technology and the growth of services, new networks and communication protocols, e.g., Internet Protocol Multimedia Subsystem (IMS) networks and session initiation protocol (SIP), have been developed to improve and implement the usage of these various services.

A characteristic of telecommunications networks is that many such networks exists (each run by a network operator) and these networks are interconnected. The interconnection may be direct between two networks, or may be indirect via one or more interconnect or transit networks. Each of these network operators will have commercial service level agreements (SLAs) with its interconnect partners and will have equipment to make routing decisions based upon 1) the destination user address and 2) the commercial SLAs. The destination user address identifies a user and this user is served by a network operator. The destination user address may be a telephone number or some email-style uniform resource identifier (URI). In the latter case, the destination user address may not readily identify the serving network operator—e.g. john@bank.com, john@baldwin.org. This presents a difficulty to the originating network operator to know how to route the request.

Accordingly, it would be desirable to provide devices, systems and methods for improving communications over a variety of interconnected networks.

### SUMMARY

Systems and methods according to exemplary embodiments address this need and others by, among other things, bi-level addressing and routing schemes to improve communications over a variety of interconnected networks.

According to an exemplary embodiment, a method for routing communications from an originating network to a destination user address via a serving network that includes the steps of: transmitting, from the originating network, a query message which includes a destination identifier that is associated with the destination user address; receiving, at the originating network, a response message which includes information that identifies the serving network associated with the destination identifier that is associated with the destination user address; embedding, at the originating network, the destination identifier that is associated with the destination user address and the information which identifies the serving network in a message; and transmitting, from the originating network, the message toward the serving network.

According to another exemplary embodiment, a method for routing communications at a communications node includes the steps of: storing a plurality of destination identifiers each of which is associated with a destination user address and corresponding serving network identification information, wherein each destination identifier that is associated with a destination user address is also associated with at least one serving network; receiving a query message which includes one of the destination identifiers that is associated with a destination user address; performing a lookup with the destination identifier that is associated with a destination user address to determine the corresponding at least one serving network; and transmitting a response message which includes information based upon the lookup which identifies at least one serving network associated with the destination identifier that is associated with a destination user address.

According to yet another exemplary embodiment, a communications node includes: a memory for storing a mapping between a destination identifier that is associated with a destination user address and at least one serving network operator that provides service to an entity identified by the destination identifier that is associated with the destination user address; a communications interface for receiving the destination identifier that is associated with the destination user address; and a processor for performing a lookup of the received destination identifier that is associated with a destination user address, wherein the lookup results in return of the at least one serving operator network when the communications interface receives a query message which includes the destination identifier that is associated with the destination user address in a session initiation protocol (SIP) message; further wherein the communications interface transmits a response message including the at least one serving operator network.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 shows a communications network framework according to exemplary embodiments;

FIG. 2 illustrates interconnecting Internet Protocol Multimedia Subsystem (IMS) networks;

FIG. 3(a) shows a European Telecommunications Standards Institution (ETSI) TS 182 025 architecture for a subscription interconnect;

FIG. 3(b) shows an ETSI TS 182 025 architecture for a peering interconnect;

FIG. 4 depicts interconnected networks according to exemplary embodiments;

FIG. 5 is a signaling diagram for routing message traffic according to exemplary embodiments;

FIG. 6 shows a communications architecture where an enterprise is associated with two serving operator networks according to exemplary embodiments;

FIG. 7 shows a signaling diagram including a response with multiple serving operator choices for routing message traffic according to an exemplary embodiment;

FIG. 8 is a communication node according to exemplary embodiments;

FIG. 9 shows a flowchart for communications routing from an originating network according exemplary embodiments, and

FIG. 10 illustrates a flowchart for communications routing from a communication node according to exemplary embodiments.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of communication networks described below. However, the embodiments to be discussed next are not limited to these systems but may be applied to other existing communication systems.

Reference throughout the specification to “one embodiment” or “an embodiment” or “exemplary embodiments” means that a particular feature, structure, or characteristic described in connection with an embodiment is included in at least one embodiment of the present invention. Thus, the appearance of the phrases “in one embodiment” or “in an embodiment” or “in exemplary embodiments” in various places throughout the specification are not necessarily all referring to the same embodiment. Further, the particular features, structures or characteristics may be combined in any suitable manner in one or more embodiments.

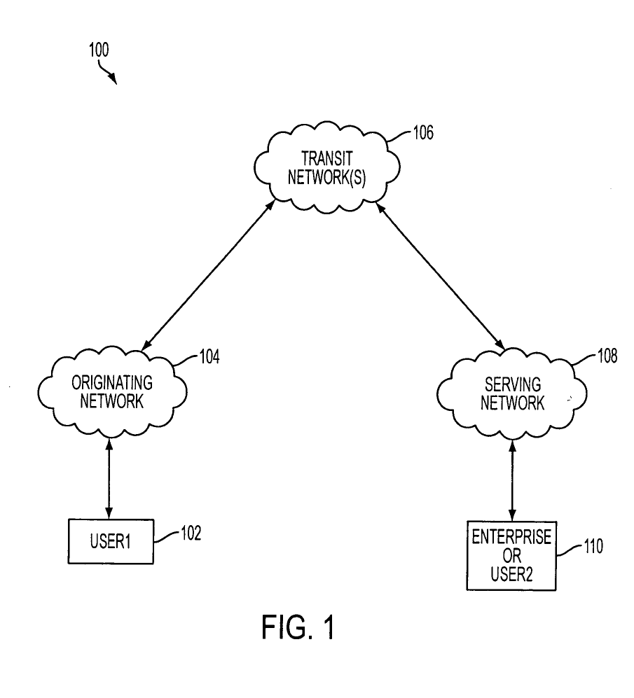

As mentioned above, it is desirable to provide devices, systems and methods for improving communications over a variety of interconnected networks. The following exemplary embodiments describe routing messages, e.g., session initiation protocol (SIP) messages, over various interconnected networks, e.g., networks which use Internet Protocol Multimedia Subsystem (IMS). In order to provide some context for this discussion, an exemplary communications framework is shown in FIG. 1.

According to exemplary embodiments, FIG. 1 shows a user communicating to another user (or a resource within an enterprise, e.g., a device or person within a company) with the communication transiting over multiple, interconnected networks. More specifically, the exemplary communications framework 100 shows User1 102 communicating to Enterprise/User2 110 with, for example, devices capable of transmitting SIP messages, e.g., mobile phones and computers. These SIP messages are first transmitted through the originating network 104, then through one or more transit networks 106 and then through the serving network 108. However, varying proposals exist regarding the domain name system (DNS) conventions used to address such messages in these varying networks, e.g., the various public telecommunication networks, and interconnecting networks, which in turn leads to challenges for the correct and efficient delivery of these SIP messages. Additionally, as used herein, “originating network”, “originating operator network” and “originating network operator” refer to the originating network that a device is connected to which initiates a call. Also, as used herein, “serving network”, “serving operator network” and “serving network operator” refer to the network which serves the end user and delivers the call to a residential user or to a user within an enterprise.

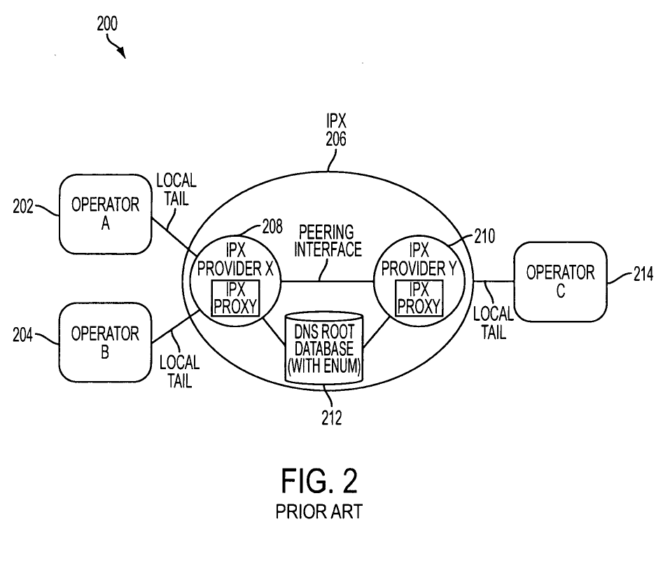

One possible framework for interconnecting IMS networks is proposed by the Global System for Mobile Communications Association (GSMA) as shown in FIG. 2. This global inter-service provider IP backbone is typically referred to as the Internetwork Packet Exchange (IPX) and is described in GSMA IR.34. Included in this framework is Operator A 202 and Operator B 204, both of which are connected to IPX Provider X 208, and Operator C 214 which is connected to IPX Provider Y 210. IPX Provider X 208 and IPX Provider Y 210 are part of the IPX 206 and are in communication with a domain name system (DNS) root database 212 with Electronic Number Mapping System (ENUM). A purpose of the IPX 206 is to facilitate interconnection between service providers according to agreed inter-operable service definitions and commercial agreements, e.g., service level agreements (SLAs). To facilitate this, the IPX 206 builds upon and extends the architecture of the general packet radio service (GPRS) roaming exchange (GRX) by introducing multiple stakeholders to this communications framework. These stakeholders can include fixed network operators, Internet service providers and application service providers. IPX 206 is expected to have its own DNS infrastructure, relevant information of which can be stored in the DNS root database 212, for routing of message traffic. The GSMA defined DNS naming convention for operators connected to the IPX is based upon using the mobile network code (MNC) and the mobile country code (MCC). An example of a unique identifier for a SIP message based upon the GSMA proposal would be as follows:

sip:+447703123456@mnc001.mcc234.3gppnetworks.org

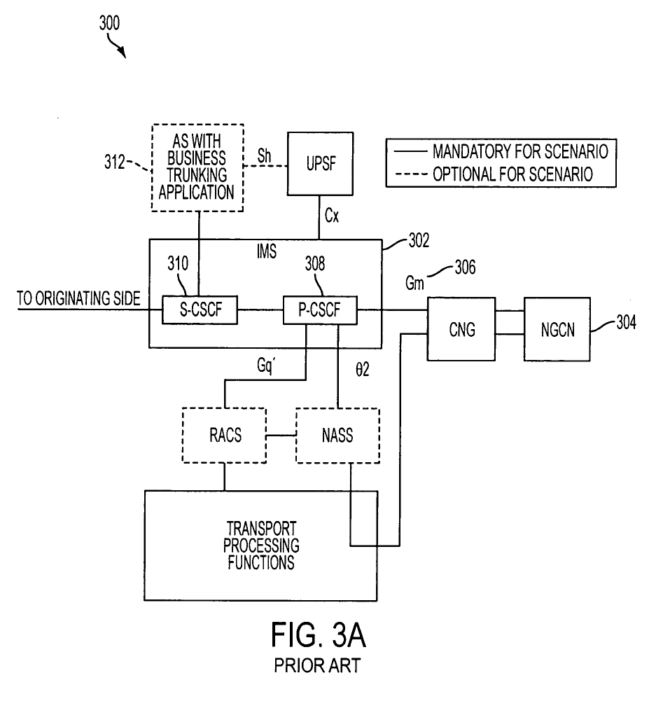

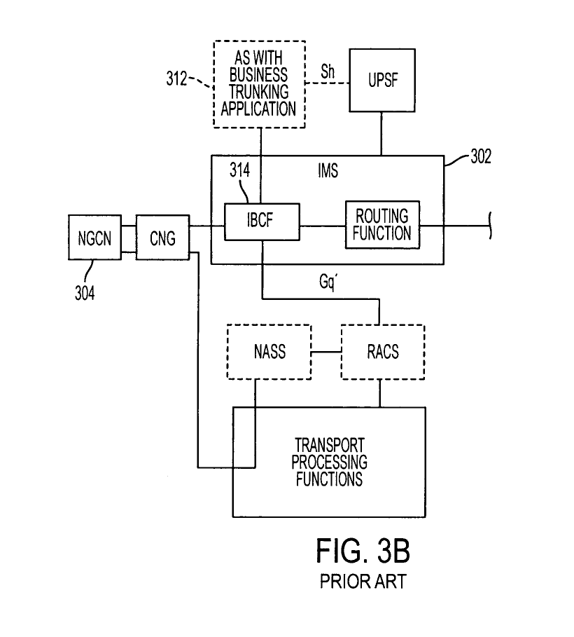

Another proposal for the interconnection of networks has been made by the European Telecommunications Standards Institution (ETSI) Telecommunications and Internet Services and Protocols for Advanced Networks (TISPAN) next generation network (NGN) release 2. More specifically, as shown in FIG. 3(a), ETSI TS 182 025 provides an architecture 300 for how a business trunking next generation corporate network (NGCN) 304 can be connected to the serving operator's IMS network 302 on a subscription basis. The Gm reference point 306 indicates the boundary between the serving operator's IMS network 302 and the corporate network. In the case of the subscription interconnect, the NGCN 304 is realized as a single user within the IMS context and the NGCN 304 is expected to perform user registration with the serving operator's IMS network 302. The serving operator's IMS network 302 can then provide services to the user through the call session control function (CSCFs), e.g., serving-CSCF (S-CSCF) 310 and proxy-CSCF (P-CSCF) 308, and an application server (AS) 312.

ETSI TS 182 025 allows for and identifies variations of the architecture shown in FIG. 3(a) for other business scenarios. In one case, as shown in FIG. 3(b), a business trunking NGCN is connected to the serving operator's IMS network 302 by a peering arrangement instead of by a subscription arrangement. In this case of a peering interconnection, there is no user within the serving operator's IMS network 302 for the NGCN 304. Instead, the NGCN 304 is represented in the serving operator's IMS network 302 by an Interconnect Border Control Function (IBCF) 314 with session information being routed through the IBCF 314.

In another case, called a Hosted Enterprise Service NGCN, each user within the NGCN 304 is realized as a single user within the serving operator's IMS network 302 and as such, each user within the NGCN 304 is expected to perform user registration with the serving operator's IMS network 302 and have services routed through the CSCFs. Also, for a large enterprise's network (or networks), there may be several instances of these connections between NGCN 304 sites and the serving operator network (or various serving operator networks) where these instances of connections may be a mixture of the three cases described above.

In each of these cases described above, using the TISPAN architecture, SIP messages can be communicated which allows a user to be addressed by a Uniform Resource Identifier (URI) of the form sip:user@domain as described in request for comments (RFC) 3261. In the case of an enterprise, e.g., a corporation, the URI could be derived from an email address and might appear as, for example, sip:john@enterprise.com or it could be derived from an Internet Protocol (IP)—Private Branch eXchange (PBX) and might appear as, for example, sip:8501234@enterprise.com;user=phone. Other allowable options include a residential user, e.g., sip:john@baldwin.org, or user-friendly operator names, e.g., sip:john@telia.se.

In the context of the proposed network architectures defined by GSMA and TISPAN, the existing standards and solutions are not definitive regarding how an originating operator can route a session addressed to a SIP URI of the forms shown above based on RFC 3261. In this area, the standards make a general reference to the use of DNS for routing sessions addressed to SIP URIs which is insufficient for large scale deployments for various reasons. For example, when multiple networks are involved, each network may have an internal DNS as well as being connected to a shared DNS such as the one proposed for IPX. However, the various standards do not describe how these different DNSs are to be set up and used. To further complicate the matter, considering that there are tens of millions of fully qualified domain names (FQDNs) on the public internet, scalability is factor since it is expected that the overall quantity of unique addresses could become similar in the interconnected networks. This can create challenges for routing traffic, e.g., SIP traffic, over multiple interconnected networks.

Additionally, operators often wish to make routing decisions based upon knowledge of their interconnects to other public networks as well as interconnect agreements to these network operators. This information is not always completely supplied by their local DNS servers and associated infrastructure. For many SIP URIs the serving network operator is not easily derived from the URI. For example, the serving network operator is not shown in SIP URIs such as sip:john@enterprise.com or sip:john@baldwin.org or john@brand_name.com. So when there are multiple ways to route a message to a particular operator, the decision on which interconnect option an originating operator uses can typically only be made based upon knowledge of the operator serving the enterprise or residential user. Also the existing charging models for telephony sessions are based partly upon geographic positions of the calling and called users, and often are also partly based upon the operators who serve the calling and called users. In other words, the operators typically want to make charging decisions based upon information about the terminating operator which is not shown in such SIP URIs as sip:john@enterprise.com or sip:john@baldwin.org. Accordingly, exemplary embodiments described below provide addressing and routing mechanisms that allow sessions addressed to SIP URIs to be routed across multiple networks to the correct destination.

As described above, the general context for these exemplary embodiments includes telephony over operator networks including various telecommunication networks and serving networks. However it will be appreciated that the present invention is not limited to telephony, but can be used to route messages of any type. These networks will typically have various potential communication paths and IBCFs which separate the various networks. Additionally, it is expected that service level agreements (SLAs) will be created detailing the necessary details for forwarding communications between these various networks so that the message traffic can reach the desired endpoint. Some of the details can include, Quality of Service requirements, costs, and addressing conventions, e.g., an agreed upon format to be used by the networks for identifying themselves.

According to exemplary embodiments, a solution for determining (e.g., by an originating network) the desired routing path of a request or message includes the originating network querying a database and receiving a response which is used to determine the message routing. For example, suppose that an originating network receives a SIP message from a user which includes a destination user address, e.g., a SIP URI of sip:john@bank.com. The originating network, acting as an originating network, does not know what serving network provides service to bank.com and therefore does not know where to send the message. The originating network then queries a serving operator database (which could include a master DNS database) with, for example, some type of a destination identifier, e.g., sip:john@bank.com, bank.com or any other type of destination identifier associated with a destination user address, and receives a response which includes information which identifies the serving network, e.g., the FQDN of the serving network or other agreed upon identifier.

According to exemplary embodiments, this serving operator database can include significantly more information than a typical network level DNS server, e.g., the serving operator database could include information for all of the FQDNs and various networks that are interconnected. By way of contrast, the network level DNS typically only holds records for the networks operators ingress points from the shared interconnect, and are run by the various operators or groups such as IPX. Thus the network level DNSs discussed herein are typically used on a per network basis to translate between domain names and IP addresses for a single operator network, whereas the serving operator database discussed herein is used, among other things, to identify serving networks associated with particular messages. Upon receiving data from a serving operator database, the originating network then determines the routing path, for example, based upon any, some, or all of the following: an in place SLA between the various networks, cost and traffic management considerations. The originating network then transmits the message towards the serving network, and includes both the destination user address and information to identify the serving operator. This use of both the destination user address and information to identify the serving operator is an example of bi-level addressing.

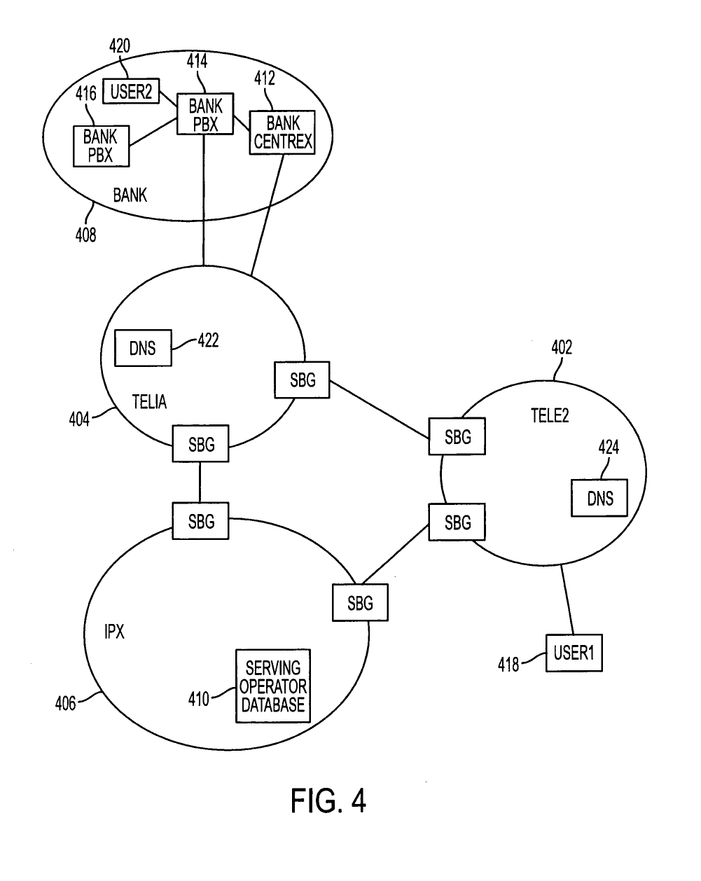

According to exemplary embodiments, various interconnected networks capable of routing communications to an enterprise (or enterprises) and individual users are shown in FIG. 4. This exemplary communications framework includes two operator networks Tele2 402 and Telia 404, IPX 406 and an enterprise's network Bank 408. The session border gateways (SBGs) are typically the access points which can also act as a firewall for communications entering and leaving the various operator networks and the IPX 406. Additionally, the operator networks Tele2 402 and Telia 404 each have their own network level DNS server 422 and 424 (or equivalent) which, at a minimum, has locally stored domain information. The serving operator database 410 includes DNS information for all of the networks associated with the IPX 406. While located in the IPX 406 in this example, the serving operator database 410 can reside anywhere that is connected and accessible to the operator networks, e.g., a third party location. The DNS information stored in the serving operator database 410 can include, for example, information describing residences and enterprises serviced by each network as reported to the serving operator database 410 by the networks, e.g., Tele2 402 and Telia 404.

The enterprise network Bank 408 includes a Bank Centrex 412 and two Bank PBXs 414 and 416 which represent where various resources and individuals are addressable. User1 418 represents a user that has service provided by Tele2 and User2 420 represents a user working for Bank 408 that is known to be associated with Bank PBX 414. Bank Centrex 412 is considered herein to be a virtual PBX. Virtual PBXs are typically associated with smaller remote business sites. For the purposes of the exemplary embodiments described herein, serving networks treat both regular and virtual PBXs similarly for the delivery of calls and messages to the end user, i.e., the exemplary embodiments described herein are not constrained by the use of either a regular or a virtual PBX.

According to exemplary embodiments described above, the serving operator database 410 includes information associated with both destination identifiers associated with users and information about their respective serving operator networks. The serving operator database 410 is able to use this information to perform a mapping between these sets of information. Additionally, this information can be in various forms. For example, general domain names, e.g., ericsson.com, telia.se and baldwin.org, can be used as well as structured telecommunication names, e.g., mnc001.mcc234, can be used for identifying various networks and users. Additionally the serving operator database 410 can perform mapping between both general domain names and structured identifiers which use the mnc and mcc.

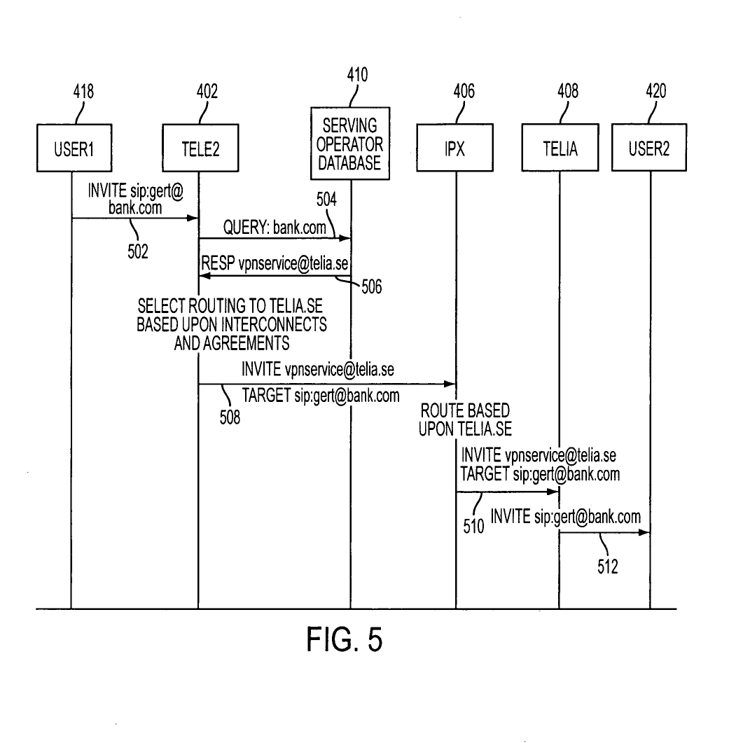

According to exemplary embodiments, message routing, e.g., calls, over the communications networks shown in FIG. 4, will now be described with respect to the signaling diagram shown in FIG. 5. Initially, User1 418 sends a message INVITE sip:gert@bank.com 502 to Tele2 402 which acts as the originating operator network. Tele2 402 does not know what network provides service to bank.com, and as such, transmits a query message 504 which includes “bank.com” (or a translated version thereof) to serving operator database 410. The serving operator database 410 performs a lookup and finds that “bank.com” is provided service by the network Telia2 404 and transmits, as part of response message 506, “vpnservice@telia.se”. Tele2 402 uses this information and determines the routing path based upon interconnects and agreements, e.g., the SLA between Tele2 402 and Telia 404.

As shown in FIG. 4, Tele2 402 is connected to Telia 404 through both a direct connection and through the IPX 406. In this case Tele2 402 chooses to route the traffic through IPX 406 as shown by message 508 which includes “INVITE vpnservice@telia.se Target sip:gert@bank.com”. IPX 406 sees in the received message 508 “telia.se” and routes the message 510 to Telia 404. Telia 404 then sends the message 512, which includes “INVITE sip:gert@bank.com, to User2 420.

As shown above, the above described routing information includes both the destination address and information which describes the network that provides service to the destination, e.g., a user or an enterprise. The latter information being made available to the originating network via the response to its query to serving operator database 410. According to exemplary embodiments, the routing information can be embedded in the SIP messages in various ways. As will be appreciated by those skilled in the art, SIP messages can include both a Request URI and a Target URI header. According to one exemplary embodiment, the serving operator identity, e.g., telia.se, can be put in the Request URI and the original SIP URI of the destination, e.g., gert@bank.com, can be put in the Target URI header of the SIP message. When the call arrives at the serving operator network, the serving operator promotes the Target URI back to the Request URI for delivery of the call on to the NGCN 304.

According to another exemplary embodiment, the serving operator identity can be appended to the Request URI, e.g., sip:john@enterprise.com.marker.mnc123.mcc234.3gppnetworks.org. Alternatively, new parameters can be put onto the SIP Request URI. For example, the serving operator can be added as a parameter on the SIP Request URI, e.g., sip:john@enterprise.com; so=mnc123.mcc234.3gppnetworks.org. According to yet another exemplary embodiment, the required serving operator information can be carried by extending other existing parameters such as the routing number (RN) or the trunk group parameter (TRGP) in a fashion similar to that described above for appending the information to the Request URI.

According to the exemplary embodiments described above, carrying both the original SIP URI and the identity of the serving operator in SIP messages allows the originating network and the transit/interconnect networks to route the messages based upon the serving operator identification information which was obtained by a central serving operator database 410. Therefore, the transit/interconnect networks do not typically need to know information about the enterprise or residential FQDNs nor do they need to query the serving operator database 410 since the serving operator network routing information is provided as part of the normal routing information for the SIP message that the transit/interconnect network knows and is able to read.

According to one exemplary embodiment, the various networks through which messages can travel each typically use separate local IP addresses internally. Therefore, traditional DNS query for IP address and routing using IP addresses is not typically used to route from the originating operator network to the serving network and on to the destination. Additionally, routing by IP addresses is not typically preferred because routing by IP address can be considered to be automatic routing which takes selection of the route used out of the control of the originating network. This does not allow the originating operator network to have control of the path and could lead to issues with SLAs as well as not being optimal for revenue.

### Multiple Instances of Serving Operators for an Enterprise

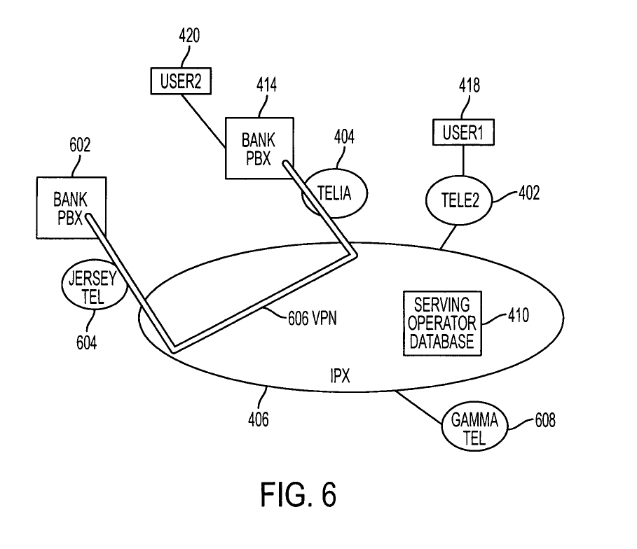

The above exemplary embodiments describe systems and methods for routing message traffic when the enterprise is served by a single serving operator network. However, for larger enterprises, there may be several instances of connections between NGCN sites and the serving operator network(s). For example, for a large enterprise network the enterprise may wish to have multiple serving operators due to widespread geographical locations of the various parts of the enterprise or for business competition reasons and the like. According to exemplary embodiments, a communications framework where an enterprise uses two different serving operator networks is described below with respect to FIG. 6.

FIG. 6 shows an exemplary communications framework which includes an IPX 406 which is connected to various operator networks, e.g., Telia 404, Tele2 402, Jersey Tel 604 and Gamma Tel 608. In this example, the IPX 406 also includes the primary DNS database 410 which includes information for mapping the FQDN of a destination to a serving network that provides service to that destination. The enterprise Bank is served by two different serving operator networks as shown with Bank PBX 414 being serviced by Telia 404 and Bank PBX 602 being serviced by Jersey Tel 604 which are connected by VPN 606. Additionally User1 418 and User2 420 are shown.

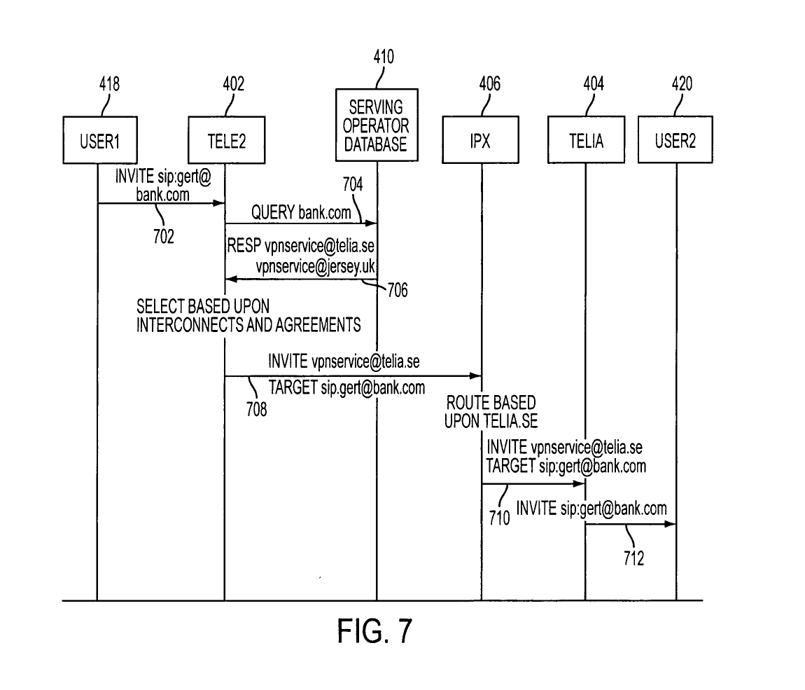

According to exemplary embodiments, a signaling flow will now be described, which uses the architecture shown in FIG. 6, for the case of having multiple serving operator networks for an enterprise as shown in FIG. 7. Initially, User1 418 sends a message 702 which includes “INVITE sip:gert@bank.com” to Tele2 402 which is acting as the originating network. Tele2 402 then sends a query message 704 which includes a destination identifier that is associated with the destination user address such as “bank.com” or “gert@bank.com” to the serving operator database 410. The serving operator database 410 performs a lookup and transmits a response message 706 which includes identification information for the two serving operator networks, e.g., vpnservice@telia.se and vpnservice@jersey.uk. Tele2 402 then decides which serving operator network to send the request to and how to route the request. These decisions can be made based on known interconnects, SLAs, geographical locations, cost and other pertinent information. Based on these decisions, Tele2 402 sends the message 708 which includes “INVITE vpnservice@telia.se and Target sip:gert@bank.com” to the IPX 406. IPX 406 sees the routing information that it needs, e.g., telia.se, and forwards the message, as shown in message 710, to Telia 404. Telia 404 then reviews the message contents and forwards them to User2 420 which is known to be gert@bank.com.

As described above, an enterprise can have various serving operator networks for different parts of the enterprise. According to exemplary embodiments, not all of the serving operator networks need to have corresponding identification or routing information stored in the serving operator database 410. Additionally, in response to the query message 704, one, some or all of the serving operator networks stored in the serving operator database 410 can be returned in the response message 706. The serving operator networks used in the response message 706 can be predetermined between the serving operator networks and the enterprise and stored accordingly in the primary DNS database 410.

According to exemplary embodiments, in the case where a wrong serving operator network receives a message, i.e., for which it determines that it does not service the destination, systems and methods can be used to further route the message to another serving operator network. In one case, a call starts in a public network by, for example, a residential user calling into an enterprise. The origination operator network selected one of the multiple serving operators (received by its query) and delivered the call to that serving operator. However, this was actually the wrong serving operator for the particular user in question. The serving operator network can query the enterprise, e.g., query a database in the enterprise for instructions on routing, and then use the bi-level addressing schemes described above to route the call to the correct serving operator network.

According to another exemplary embodiments, a call can begin in an enterprise, e.g., an enterprise user, to another enterprise user. The destination enterprise user is a part of the enterprise network that is served by a different serving network operator from the originating enterprise user. In this case, the case known as on-net calls, the call needs to be routed across the various interconnected networks to the correct serving operator network. The bi-level addressing schemes described above can also be used to forward this call to the correct serving operator.

### Domain Name Portability

According to exemplary embodiments, implementation of the above described systems and methods allow for domain name portability. Domain name portability, as used herein, describes moving the domain of a user or an enterprise from one serving operator to another serving operator with minimal overhead or effort. For example, as described above, the serving operator database 410 used in these exemplary embodiments is separate from the typical network level DNS databases 422, 424 used by each network. This serving operator database 410 is updated by each network as determined by the provider of the serving operator database 410 and each network operator, but preferably in a timely manner when changes occur, which facilitates domain name portability.

For example, assume that enterprise Bank 408 is using Telia 404 as its service provider. The enterprise Bank 408 then decides to change to Tele2 402 as its service provider, i.e., the point(s) of connection from Bank 408 to the serving network is changed to the new serving network but the internal addressing within Bank 408 does not typically change, e.g., individual SIP URIs, extensions and direct dialing inwards (DDI) numbers would remain the same. Once this change is made, then Tele2 402 updates the serving operator database 410 of the change. Changes do not typically need to be made at the lower levels of the DNS infrastructure, except in the two networks directly affected by this change. Additionally, internal changes within the network structure of Bank 408 would not, for the most part, need to be modified. This process would also be true for residential use. For example, if a user had a domain name of gert@baldwin.org and changed serving operator networks, the domain name could be ported over to the new serving operator network and still be used with a seamless transition for gert@baldwin.com.

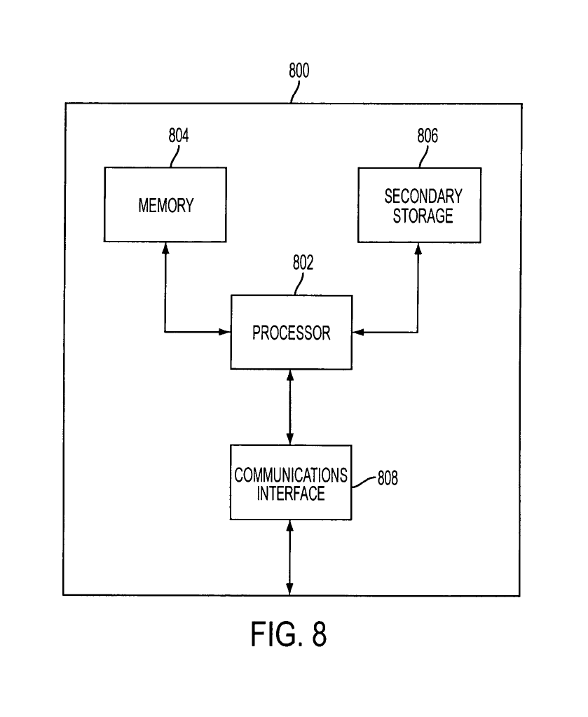

The exemplary embodiments described above, illustrate methods and systems for using a serving operator database 410 to store destination address information that is matched to its serving operator network which is used for routing traffic over interconnected networks, e.g., interconnected IMS networks. An exemplary communications node 800, representing a serving operator database 410, will now be described with respect to FIG. 8. Communications node 800 can contain a processor 802 (or multiple processor cores), memory 804, one or more secondary storage devices 806, a communication interface unit 808 to facilitate communications. The memory 804 (or secondary storage devices 806) can be used for storage of the destination addresses, e.g., FQDNs, and the serving operator networks that service those destinations. Thus, a communications node 800, according to exemplary embodiments, is capable of receiving a query and returning the serving operator network (or networks) associated with the destination. Additionally, communications node 800 is capable of performing functions of other nodes described above in the various communications networks, such as, a network level (local) DNS server or a combination of a DNS server and serving operator database 410.

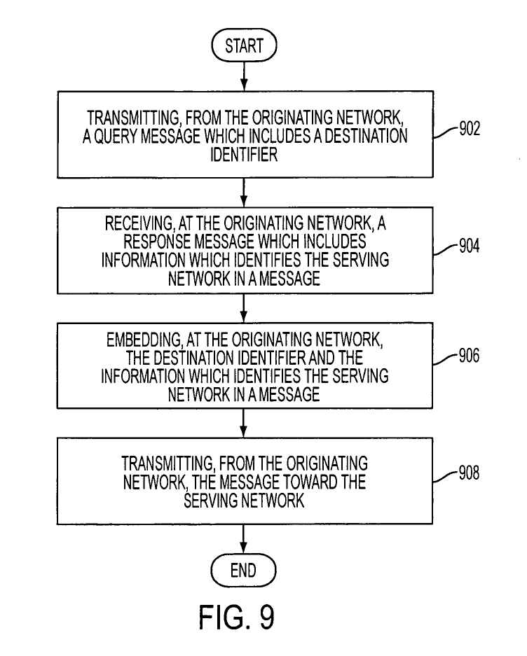

Utilizing the above described exemplary systems according to exemplary embodiments, a method for routing communications is shown in the flowchart of FIG. 9. Initially, a method for routing communications from an originating network to a destination user address via a serving network includes: transmitting, from the originating network, a query message which includes a destination identifier that is associated with the destination user address in step 902; receiving, at the originating network, a response message which includes information which identifies the serving network associated with the destination identifier that is associated with the destination user address in step 904; embedding, at the originating network, the destination identifier that is associated with the destination user address and the information which identifies the serving network in a message in step 906; and transmitting, from the originating network, the message toward the serving network in step 908.

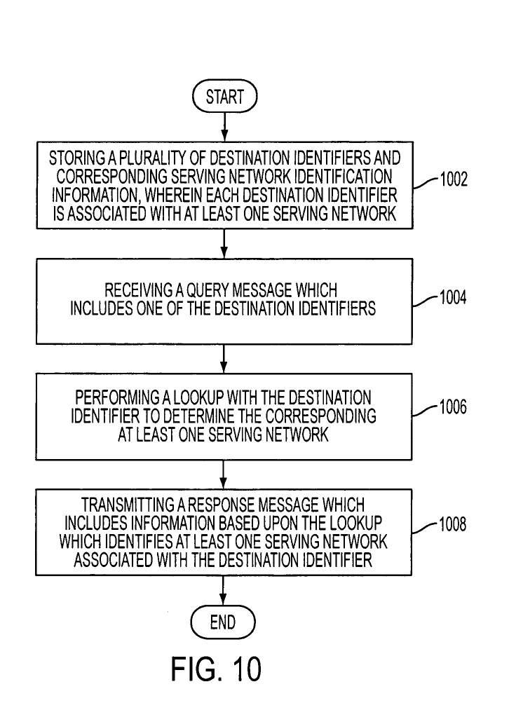

Utilizing the above described exemplary systems according to exemplary embodiments, a method for routing communications is shown in the flowchart of FIG. 10. Initially, a method for routing communications at a communications node includes: storing a plurality of destination identifiers each of which is associated with a destination user address and corresponding serving network identification information, wherein each destination identifier that is associated with said destination user address is also associated with at least one serving network in step 1002; receiving a query message which includes one of the destination identifiers that is associated with a destination user address in step 1004; performing a lookup with the destination identifier that is associated with a destination user address to determine the corresponding at least one serving network in step 1006; and transmitting a response message which includes information based upon the lookup which identifies at least one serving network associated with the destination identifier that is associated with a destination user address in step 1008.

The above disclosed exemplary embodiments describe systems and methods associated with routing message traffic over interconnected networks. It should be understood that this description is not intended to limit the invention. For example, the above described exemplary embodiments could be implemented for routing calls over interconnected IMS networks between two individual users each using a mobile phone. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein. The methods or flow charts provided in the present application may be implemented in a computer program, software, or firmware tangibly embodied in a computer-readable storage medium for execution by a general purpose computer or a processor.

1. A method for routing communications from an originating network to a destination user address via a serving network comprising:
transmitting, from said originating network, a query message which includes a destination identifier that is associated with said destination user address;
receiving, at said originating network, a response message which includes information which identifies said serving network associated with said destination identifier that is associated with said destination user address;
embedding, at said originating network, said destination identifier that is associated with said destination user address and said information which identifies said serving network in a message; and
transmitting, from said originating network, said message toward said serving network.

2. The method of claim 1, wherein said message is a session initiation protocol (SIP) message.

3. The method of claim 2, wherein said step of embedding further comprises:
placing said destination identifier that is associated with said destination user address in a target uniform resource identifier (URI) header of said SIP message and said serving network identification information in a request URI of said SIP message.

4. The method of claim 2, wherein said step of embedding further comprises:
placing said destination identifier that is associated with said destination user address in a request URI of said SIP message and appending said serving network identification information to said request URI of said SIP message.

5. The method of claim 2, wherein said step of embedding further comprises:
placing said destination identifier that is associated with said destination user address in a request URI header of said SIP message and adding said serving network identification information as a new parameter in said SIP request URI of said SIP message.

6. The method of claim 2, wherein said step of embedding further comprises:
placing said destination identifier that is associated with said destination user address in a request URI header and appending said serving network identification information using an existing parameter in said SIP message.

7. The method of claim 6, wherein said existing parameter in said SIP message is at least one of a routing number and a trunk group parameter.

8. The method of claim 1, further comprising:
receiving, in said response message, identification information for a plurality of serving networks associated with said destination identifier that is associated with said destination user address;
determining the routing of said message to one of said plurality of serving networks based on at least one of cost, service level agreement and traffic management considerations.

9. The method of claim 1, wherein said destination identifier that is associated with said destination user address is associated with at least one of a residence and an enterprise.

10. The method of claim 1, wherein said destination identifier that is associated with said destination user address is a fully qualified domain name (FQDN).

11. The method of claim 1, wherein said destination identifier that is associated with said destination user address is a portion of a FQDN.

12. A method for routing communications at a communications node comprising:
storing a plurality of destination identifiers each of which is associated with a destination user address and corresponding serving network identification information, wherein each destination identifier that is associated with said destination user address is also associated with at least one serving network;
receiving a query message which includes one of said destination identifiers that is associated with a destination user address;
performing a lookup with said destination identifier that is associated with said destination user address to determine said corresponding at least one serving network; and
transmitting a response message which includes information based upon said lookup which identifies at least one serving network associated with said destination identifier that is associated with said destination user address.

13. The method of claim 12, wherein said at least one serving network is multiple serving networks.

14. The method of claim 12, further comprising:
supporting message routing within said at least one serving network, wherein said at least one serving network includes a domain name system (DNS) server, further wherein said DNS server is different from said communications node.

15. The method of claim 12, wherein said communications node is a database.

16. The method of claim 12, further comprising:
receiving a message or database management action indicating a change between one of said destination identifiers that is associated with said destination user address and said corresponding at least one serving network; and
updating said stored correspondences based upon said received message.

17. The method of claim 12, wherein said destination identifier associated with said destination user address identifies an enterprise.

18. The method of claim 12, wherein said destination identifier associated with said destination user address identifies a residential user.

19. A communications node comprising:
a memory for storing a mapping between a destination identifier that is associated with a destination user address and at least one serving network operator that provides service to an entity identified by said destination identifier that is associated with said destination user address;
a communications interface for receiving said destination identifier that is associated with said destination user address; and
a processor for performing a lookup of said received destination identifier that is associated with said destination user address, wherein said lookup results in return of said at least one serving operator network when said communications interface receives a query message which includes said destination identifier that is associated with said destination user address in a session initiation protocol (SIP) message; further wherein said communications interface transmits a response message including said at least one serving operator network.

20. The communications node of claim 19, wherein said at least one serving network is multiple serving operator networks.

21. The communications node of claim 19, wherein each of said at least one serving network includes a domain name system (DNS) server for supporting message routing within said serving network, further wherein said DNS server is different from said communications node.

22. The communications node of claim 19, wherein said communications node is a database.

23. The communications node of claim 19, wherein said mapping between a destination identifier that is associated with said destination user address and at least one serving network operator that provides service to an entity identified by said destination identifier that is associated with said destination user address, occurs between a general domain name and a structured name.

24. The communications node of claim 23, wherein said structured name is of a format mncxxx.mccyyy with mnc being a mobile network code and mcc being a mobile country code.
